(19) United States
(12) Patent Application Publication
(10) Pub. No.: US 2021/0235922 A1
(43) Pub. Date: Aug. 5, 2021

(54) SYSTEM WITH KITCHEN APPLIANCES FOR A COORDINATED COOKING AND PROCESS

(71) Applicant: Vorwerk & Co. Interholding GmbH, Wuppertal (DE)

(72) Inventors: Matthias Stein, Mülheim an der Ruhr (DE); Marian Rogge, Düsseldorf (DE)

(21) Appl. No.: 17/160,318

(22) Filed: Jan. 27, 2021

(30) Foreign Application Priority Data
Jan. 30, 2020 (EP) 20154494.7

(51) Int. Cl. A47J 36/32; A47J 43/046; A47J 43/07; G05B 15/02

(52) U.S. Cl. CPC A47J 36/32; A47J 43/046; A47J 2043/0733; G05B 15/02; A47J 43/0722

(57) ABSTRACT

The present disclosure relates to a system having at least two kitchen appliances; an electronic resource storage device for storing a list of kitchen appliances comprised by the system and/or for storing the number of users which are available for the preparation of one or more foods; a recipe storage device for storing a recipe for the preparation of a food; an optimizing device configured such that it optimizes the preparation of one or more foods, taking into account information for the system comprised by a recipe; a control device for the preparation of one or more foods according to a sequence of process steps optimized by the optimizing device. The present disclosure also relates to a method for preparing a food using the system.

### CROSS REFERENCE TO RELATED APPLICATIONS

This application claims priority to and the benefit of European Patent Application No. 20 154 494.7, filed 30 Jan. 2020, the disclosure of which is now expressly incorporated herein by reference.

### FIELD OF THE DISCLOSURE

The present disclosure relates to a preparation of food with kitchen appliances according to a recipe, namely both a system and a method.

### BACKGROUND

The Thermomix® TM6 food processor for the preparation of a food according to a recipe is known from the prior art. The Thermomix® food processor comprises a vessel with a mixing and cutting tool located therein, a scale for weighing an ingredient filled into the vessel, a heating device for heating the vessel and a control device for controlling the food processor. The Thermomix® food processor allows setting a rotation speed of the mixing and cutting tool, setting a rotation direction of the mixing and cutting tool, setting a desired temperature in the vessel, setting a time for the rotation of the mixing and cutting tool at a desired speed and for heating.

A mixing and cutting tool in the sense of the present disclosure may comprise a blunt edge and an opposing sharp edge. A user can prepare a food according to a Thermomix® recipe particularly reliably by means of this food processor, because Thermomix® recipes include step-by-step instructions as to which steps of the recipe are to be performed with which settings in the Thermomix® food processor according to which sequence. Settings can even be made in a semi-automated manner during the preparation of a food. A Thermomix® recipe therefore provides the user with precise instructions at the appropriate time as to which ingredients are to be processed in which quantities with which settings. A Thermomix® recipe can therefore precisely specify the rotation speed of the mixing and cutting tool, the rotation direction of the mixing and cutting tool, the duration and, if necessary, the temperature to be set. The Thermomix® food processor has a display on which recipe steps to be performed, including the settings to be made, can be shown one after the other. This makes it possible even for inexperienced users to prepare a food in a reproducible manner. Further information and details are given in the USER MANUAL of the Thermomix® TM6 food processor.

### SUMMARY

A mixing device in the sense of the present present disclosure is a kitchen appliance with a vessel and a mixing tool located therein, which can be rotated at only low speed and low torque compared to the food processor Thermomix® TM6. In particular, such a mixing device may not be not suitable for kneading dough due to the low torque. A mixing and cutting tool having a blunt edge and an opposite sharp edge can also be used as a mixing tool in a mixing device. This can then also be used in a food processor for chopping ingredients. In such a case, the mixing device can preferably rotate the mixing tool only in the direction of its blunt edge. Since the range of functions of a mixing device is small compared to range of functions of a food processor, its installation space is in principle small compared to the installation space of a food processor.

Some food mixers have a small installation space (size) compared to the installation space of a common food processor. In contrast to the mixing device of the present disclosure, such a mixer may be configured for chopping ingredients. Such a mixer therefore has a cutting tool, which can be rotated at high speed in the direction of its sharp edge in order, for example, to be able to chop fruits for the production of a fruit drink.

A mixer in the sense of the present disclosure is therefore a kitchen appliance with a vessel and a cutting tool. Since the range of functions of a mixer is small compared to the range of functions of a food processor, its installation space is in principle small compared to the installation space of a food processor.

It is the task of the present disclosure to further facilitate the preparation of a food. A system with at least two kitchen appliances serves to solve the task. A kitchen appliance is an appliance with the help of which a food can be prepared. The term food also comprises a liquid food, i.e. also a soup or a drink. A kitchen appliance can be, for example, a food processor, a mixing device, an oven, a microwave oven, an electric kettle, a hob with a frying pan or with a cooking pot, a steamer, a mixer, a refrigerator or a freezer.

The system comprises an electronic resource storage device for storing a list of kitchen appliances comprised by the system and/or for storing the number of users which are available for the preparation of one or more foods. For example, it may be stored in the electronic resource storage device that the system comprises a food processor and a mixing device. The system then comprises the food processor and the mixing device as kitchen appliances. For example, it may be stored in the electronic resource storage device that two users are available. Then manual activities can be carried out by two different persons.

The system comprises an electronic recipe storage device for storing a recipe for the preparation of a food. A recipe, i.e. a systematic instruction for the preparation of the food, may be stored in the storage device.

### BRIEF DESCRIPTIONS OF THE DRAWINGS

The figures show

FIG. 1: a schematic representation of a food processor;

FIG. 2: a schematic representation of other kitchen appliances; and

FIG. 3: a schematic representation of a computer.

### DETAILED DESCRIPTION

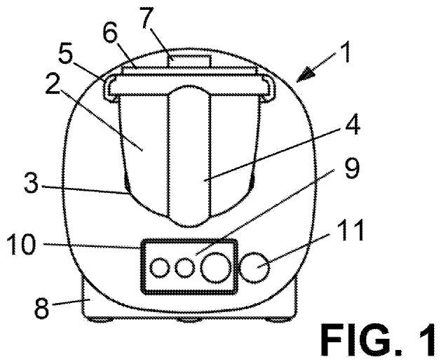

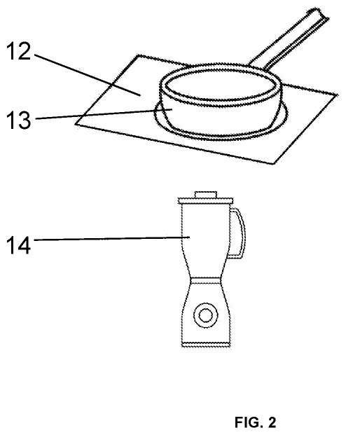

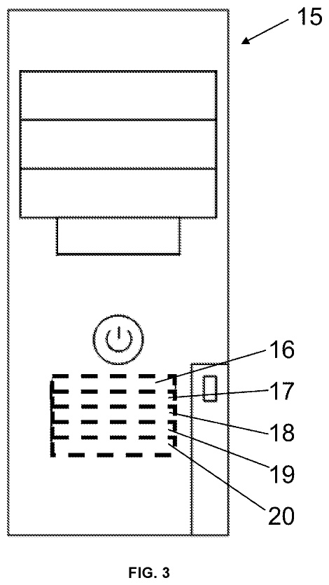

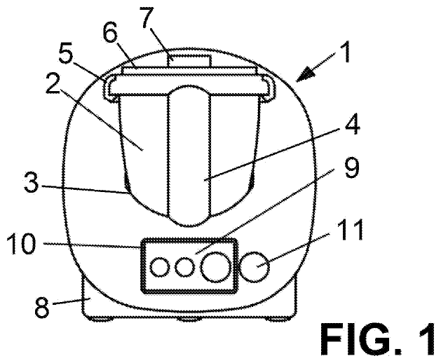

FIG. 1 shows a food processor 1 which can be part of a system according to the present disclosure. The food processor 1 comprises as food preparation space a vessel 2, which is inserted into a holder 3 of the food processor 1. The vessel 2 comprises a handle 4 for easily removing the vessel 2 from the holder 3. The food processor 1 comprises a closing mechanism with pivotally mounted arms 5. In the closed position shown in FIG. 1, the arms 5 enclose a lid 6. As a result, the lid 6 is then firmly connected to the vessel 2. The lid 6 comprises an opening into which a transparent vessel 7, for example, is inserted. The opening in the lid 6 is closed by the vessel 7. The vessel 7 can be lifted off the opening at any time, so that an opening is then provided through which an ingredient can be filled into the vessel 2. The vessel 7 can serve as a dispensing aid. If the closing mechanism is opened, then the lid 6 can be removed from the vessel 2. The food processor 1 comprises a foot part 8 for setting up.

A user interface 9 is displayed on a screen 10. The screen 10 is preferably touch-sensitive, for example to be able to set operating parameters by touching the screen. The food processor may also comprise, for example, a control dial 11, which can also serve to set one or more operating parameters in conjunction with the user interface 9. For example, if the user interface 9 relates to a mixing and cutting device of the food processor 1, the control dial 11 can e.g. be used to set a rotation speed. If the user interface 9 refers, for example, to a warming or heating of the vessel 2 of the food processor 1, the control dial 11 can be used, for example, to set a desired temperature. Instead of a control dial 11, however, a slide control 11 can also be provided, for example, in which operating parameters such as temperature, mixing speed or a time period can be set by a sliding movement. In one embodiment, however, temperature, mixing speed or time period can also be entered numerically. A control dial 11 is preferable, however, since large ranges can be set very easily without having to provide too much space for this purpose. The control dial 11 can alternatively or additionally be designed as a push button. A push button means that it can be pressed to trigger an action, such as starting a preparation of one or more foods.

The food processor 1 shown in FIG. 1 may comprise an interface for an exchange of electronic data. It may be a wireless interface. Through the interface, the food processor 1 can be connected to another kitchen appliance and/or to a computer that is spatially separated from the food processor 1.

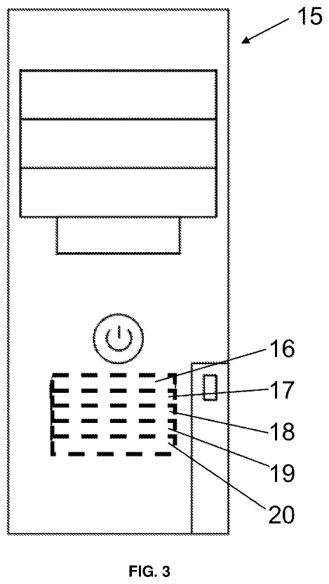

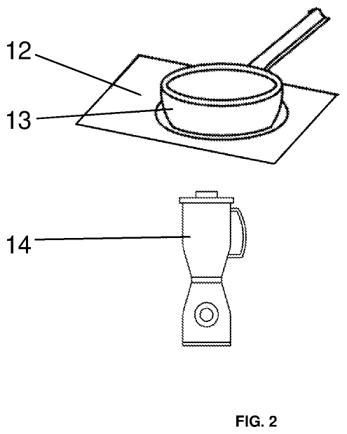

The system may comprise one or more of the further kitchen appliances shown in FIG. 2, namely a cooktop 12 with a pan 13 as one kitchen appliance and a mixing device 14 as another kitchen appliance. Both kitchen appliances may comprise an interface through which electronic data can be exchanged, for example with each other, with the food processor 1 and/or with an external computer, which may be spatially separated from the kitchen appliances.

In the FIG. 3 schematically devices of a computer 15 are shown, namely:

an electronic resource storage device 16, having stored therein a list of the kitchen appliances 1, 12, 13, 14;

a recipe storage device 17, having stored therein a plurality of recipes for the preparation of foods;

an optimizing device 18, configured such that it optimizes the preparation of one or more foods, taking into account information for the system comprised by the recipe; a control device 19 for the preparation of one or more foods according to a sequence of process steps optimized by the optimizing device;

a selection device 20 configured such that the selection device selects in an automated manner from possible kitchen appliances stored in the resource storage device, based on at least one selection criterion, when a process step can be performed with different kitchen appliances stored in the resource storage device.

A computer 15 configured in this way can be integrated in one of the kitchen appliances 1, 12, 13, 14. The computer 15 can be physically separated from the kitchen appliances 1, 12, 13, 14 and connected to the kitchen appliances 1, 12, 13, 14 via an interface such that data can be exchanged electronically. However, the computer 15 can also comprise only a part of the devices 16, 17, 18, 19, 20 shown in FIG. 3. Devices that are not available on the computer 15 may then be available on one of the other kitchen appliances, for example. For example, computer 15 may lack the control device 19. Instead, the control device 19 may, for example, be integrated in the food processor 1.

The computer 15 and/or a kitchen appliance 1, 12, 13, 14 may comprise an input device.

According to the present disclosure, a recipe is subdivided into a plurality of process steps. A process step is a step that must be carried out for the preparation of a food. For example, it is provided according to the recipe that Parmesan cheese is to be ground by a food processor or mixer. The recipe may then comprise the following process steps.
first process step: add Parmesan cheese in the vessel of the food processor or mixer;
second process step: place the lid on the vessel;
third process step: chop the Parmesan cheese in the vessel for 10 seconds at maximum rotation speed.

Process step therefore means a single, coherent activity of a user or a kitchen appliance, which, in principle, cannot be further subdivided.

The recipe includes for each process step information for the system, which can be interpreted by the system.

Information for the system means that the information is available to the system in such a way that the system can process the available information and thereby optimize an instruction for preparing a food. An information for the system is not present if a user can receive and understand information, but this information is not available in a form that the system can “understand” in order to be able to use the information for optimization calculations.

The information may comprise a time specification for a process step, i.e. the time required for carrying out the process step. In particular, there may be a time specification for each process step of a recipe. For example, the recipe includes information for the system that 10 seconds of time is required for the aforementioned first process step, 5 seconds of time is required for the aforementioned second process step, and 15 seconds of time is required for the aforementioned third process step. For the third process step, for example, 15 seconds (and not only 10 seconds) may be specified, because it comprises that in one working step of the kitchen appliance the placed lid is locked in an automated manner by the kitchen appliance before chopping and is unlocked in an automated manner following chopping and automated chopping is performed in between.

The information may comprise for a process step an indication of which kitchen appliance is required for carrying out the process step. For one process step, two or more kitchen appliances may be available for selection. For each of the three process steps mentioned above, the recipe can therefore comprise the information that a food processor or a mixer is required.

The information may comprise for a process step the indication that a user is needed for carrying it out. For example, the first and second of the process steps mentioned above may comprise the indication that the user is required because “add Parmesan cheese in the vessel of the food processor or mixer” and placing a lid require a manual action by a user. “Peel onions” is another example of a process step for which the indication may be provided that this process step is to be performed by a user of the system. Peeling onions is an example of a process step for the performing of which no kitchen appliance is used.

The information may comprise that a process step is dependent on another process step. This means that the first mentioned process step can only be performed after the other process step has been performed. Thus, the recipe may include the information for the system that the aforementioned third process step depends on the second process step. The recipe may include the information for the system that the aforementioned second process step depends on the aforementioned first process step.

The system comprises an optimizing device configured such that it optimizes the preparation of one or more foods, taking into account the information for the system. This means that the optimizing device can change the sequence of process steps based on the information, or at least combine the process steps of two recipes, so that a new sequence of process steps is created, by which a specified target is reached. For example, a first recipe comprises three process steps R11, R12, R13 and a second recipe comprises three process steps R21, R22 and R23, which are to be performed in this sequence according to the recipe. As target it is specified that the two foods should be finished as fast as possible. The optimizing device now calculates which sequence of process steps can prepare the two foods as quickly as possible. The optimizing device uses the information provided to the system for the calculation. For example, the calculation may have shown that the process steps are to be carried out in the following sequence in order to prepare both foods in the shortest possible time: R22, R21, R11, R12, R23, R13. The optimizing device has thus changed the sequences provided by the two recipes and created a single new sequence from the two sequences, thus achieving a desired optimization target. A process step-by-process step instruction is thus available, according to which also a plurality of foods can be prepared. This is done in an optimized manner according to a selected optimization target.

The system comprises a control device for a preparation of one or more foods according to an optimized sequence of process steps created by the optimizing device. The control device is configured such that it instructs the one or more users which process steps in which sequence are to be carried out and how, if necessary, which kitchen appliances are to be selected for the food preparation and how settings of these are to be made. The control device may also be configured such that it makes settings to kitchen appliances in an automated manner. For example, the system may comprise a screen indicating that a user is to fill two tablespoons of oil into the vessel of a food processor according to process step R22. According to the subsequent process step R21, the user is to peel two onions. According to a subsequent process step R11, a hob with a frying pan on it is to be heated. The user is then prompted, for example via a screen, to confirm the performance of the process step, for example by touching a displayed field on the then touch-sensitive screen. Once the user has touched the field, the control device automatically sets a provided temperature to which the cooktop is then heated. Alternatively, the user may be prompted via the screen to manually set a temperature shown on the display. For example, a rotary control can be provided for this purpose, a rotation of which can be used to set a desired temperature. For this purpose, an input field for a desired temperature can be provided on the then touch-sensitive screen.

The system makes it possible to carry out a preparation of several foods in an optimized manner according to a recipe, taking into account the available resources, i.e. the available kitchen appliances and/or the number of users available for carrying out manual activities. This applies especially when a plurality of foods are to be prepared in parallel, using more than one kitchen appliance. The recipe(s) provide the optimizing device with the necessary information to prepare a food or a plurality of foods, for example, in parallel and, for example, in a time-optimized manner and in an instructed form. A process step-by-process step instruction for the preparation of a food can take place via a screen. Alternatively or additionally, a voice output via a loudspeaker of the system can be provided to guide a user. A process step-by-process step instruction need not be output in such a way that each process step is output in its entirety. The output may be limited to what is required for a user for the preparation of a food. Thus, in principle, the output does not comprise information about dependencies.

In one embodiment, the optimizing device can also take into account during an optimization that at least two different kitchen appliances can be used for performing a process step. In this embodiment, the optimizing device may select kitchen appliances from the kitchen appliances stored in the resource storage device such that the desired optimization target is achieved by this selection. For example, the optimizing device calculates the speed of preparation of one or more foods in case a mixing provided according to a process step is carried out by an available food processor, i.e. a food processor stored in the electronic resource storage device, and on the other hand by an available mixing device, if one or more foods are to be prepared as fast as possible.

The optimizing device may comprise an input device through which a desired optimization target can be inputted and thus specified. For example, it may be specified as an optimization target by means of the input device that selected foods should be finished at the same time and as quickly as possible. Following such an optimization, the control device can control the preparation of the foods and instruct one or more users accordingly such that the foods are prepared in parallel in the shortest possible time in such a way that the foods are finished at the same time. For example, it may be specified as an optimization target by means of the input device that selected foods are to be finished in such a way that the number of kitchen appliances used is minimized. Following such an optimization, the control device can control the preparation of the foods and instruct one or more users accordingly such that the selected foods are prepared in such a way that the number of kitchen appliances required for this is as small as possible. For example, it may be specified as an optimization target by means of the input device that a first food is to be finished at a first time and a second food is to be finished later in time, such as 30 minutes later. Following such optimization, the control device can control the preparation of the foods and instruct one or more users accordingly such that one food is prepared at a first time and the other food is prepared at a desired later time. For example, it may be specified as an optimization target that a first food is to be finished at a first time and a second food is to be finished at a later time, and further that following finishing the first food, a user is required to take as little action as possible. Following such optimization, the control device may control the preparation of the food and instruct one or more users accordingly such that one food is prepared at a first time and the other food at a desired later time. After completion of the first food, a user need only take minimized action. The user can then finish two foods at desired different times according to a process step-by-process step instruction.

The control device can be configured such that it signals acoustically, for example, when a user needs to take action.

A keyboard may be provided as input device. A keypad may be provided as an input device. A microphone together with a speech recognition may be provided as input device.

In one embodiment, the optimizing device is configured such that it can calculate the sequence of process steps backwards. This means that the optimizing device starts its calculations with a last process step provided according to a recipe and calculates an optimization from here, for example a shortest time duration. The same applies to two or more recipes. This embodiment makes it possible that selected foods are finished at the same time. Finishing at the same time does not mean that two foods can be finished to the second. It is sufficient if, according to a process step-by-process step instruction, the selected foods are finished within a period of time of a few minutes, for example within a period of time of not more than five minutes, preferably within not more than three minutes, particularly preferably within one minute.

By calculating backwards, it is also possible to be able to finish two different foods at desired different times.

In one embodiment, the optimizing device is configured such that it calculates the sequence of process steps backwards and also that a time for the completion of foods can be inputted via an input device, for example 12:30. By being able to calculate backwards, the optimizing device can then also calculate when to start preparing food so that the one or more desired foods are finished at 12:30. In interaction with the control device, a user can then be instructed at what time to start with the preparation of food.

In one embodiment, a first time may be selected for a first food and a second time may be selected for a second food. In one embodiment, a first time may be selected for one or more first foods and a second time may be selected for one or more second foods, etc.

The electronic resource storage device may comprise an input device through which the number of users and/or the available kitchen appliances can be entered for storage. For example, the input device can be used for inputting that a food processor and a mixing device are available. Following the inputting, the resource storage device stores that a food processor and a mixing device are available. For example, it can be inputted how many users are available. Following the inputting, it is stored in the resource storage device how many users are available.

The electronic resource storage device can be configured such that it recognizes and stores available kitchen appliances in an automated manner. Available kitchen appliances can then be or become connected to the resource storage device accordingly. This may be a wireless connection, for example a Bluetooth connection or Wi-Fi connection. For example, once a food processor is connected to the electronic resource storage device, the resource storage device then detects that a food processor is available and stores this information.

The electronic resource storage device can be configured such that it recognizes available users in an automated manner, for example, by means of a camera.

The optimizing device can be configured such that it calculates, for example, the speed, if speed is the optimization target, for all possible combinations of the sequence of process steps in order to finally find a sequence of process steps by which a specified optimization target is achieved. The optimizing device can thus be configured such that it calculates the time required to finish selected foods for all possible combination possibilities. Subsequently, the optimizing device may identify the combination possibility for which the shortest time is required.

The optimizing device may be configured such that it calculates the number of kitchen appliances required for all possible combination possibilities, for example, in order to find the combination with the lowest number of kitchen appliances required.

Combination possibility means a sequence of process steps that is possible. If a second process step is mandatory to be carried out following a first process step and if this information is stored for the system, then carrying out the first process step after the second process step is not a combination possibility in the sense of the present disclosure, because this sequence of process steps is not possible.

The optimizing device may comprise an optimization program that can find a sought-after optimal combination by means of an algorithm. Suitable optimizing programs are commercially available.

In one embodiment, a recipe for a process step includes information for the system on which other process step the process step is dependent, wherein a distinction is made between at least two different dependencies. For example, a distinction can be made between a direct and an indirect dependency.

There is a direct dependency between a first and a second subsequent process step if the second process step must be performed with the same kitchen appliance immediately after the first process step. It is then not possible to first perform the first process step with the kitchen appliance, followed by a third process step and then the second process step. It is also not possible to perform the second process step before the first process step.

There is an indirect dependency between a first and a second subsequent process step, if a third process step can be performed between a first and a second process step, wherein the first and the second process step are not performed with the same kitchen appliance. It is again not possible to perform the second process step before the first process step.

If a second process step must be carried out immediately after a first process step with a kitchen appliance, this is a direct dependency. If this information is stored for the system, then the sequence first process step, third process step, second process step is not a sequence that is possible, wherein the third process step is a process step that is also to be carried out with the kitchen appliance. The sequence first process step, third process step, second process step is then no combination possibility, which the optimizing device can consider.

If a second process step must be carried out following the carrying out of a first process step and if the same kitchen appliance is not required for both process steps, and if a third process step can be carried out between the first process step and the second process step, then this is an indirect dependency. If this information is stored for the system, then the sequence first process step, third process step, second process step is a sequence that is possible, and thus a combination possibility that the optimizing device can consider. Performing the second process step before the first process step is then not a combination possibility that the optimizing device can consider.

For example, onions are to be chopped and steamed. The manual peeling of the required one or more onions is then a first process step. This process step is carried out manually by the user of the system. The second process step is the addition of the peeled onions into the vessel of the food processor. The second process step depends on the first process step, because the onions can only be added to the vessel after the onions have been peeled. This is an indirect dependency because after the onions have been peeled, it is not immediately necessary for a user to bring the onions into the food processor vessel. Instead, between these two process steps, the user can carry out a third process step that requires a manual activity. Once the peeled onions have been brought into the vessel, the vessel opening must be closed with a lid in order to continue. The placing of a lid is then a third process step, which depends on the second process step. It is a direct dependency because the placing of a lid must be done immediately after the peeled onions have been placed in the vessel, and the food processor cannot be used in any other way in the meantime. A fourth process step is then the chopping of the onions by the food processor. According to the fourth process step, it can be specified to chop the onions for 3 seconds at level 5. The fourth process step depends on the third process step. This is again a direct dependency, as the same food processor is used and the food processor cannot be used for carrying out another process step between the third and the fourth process step. The fifth process step is the addition of two tablespoons of oil to the vessel. In the case of the food processor Thermomix® TM 6, the lid does not have to be removed for this, as the lid has an opening through which oil can be added. The fifth process step depends on the fourth process step. This is again a direct dependency, since both process steps are carried out by the same food processor and it is not possible for the food processor to perform another process step in between. The sixth process step is to heat the vessel. According to the sixth process step, it can be specified to heat the vessel to 100° C. for three minutes while rotating the mixing tool at the rotation speed of level 1. The sixth process step depends on the fifth process step. Since the food processor cannot be used for any other purpose between these two process steps and the same food processor is to be used for both process steps, this is again a direct dependency.

An external and a direct dependency can be represented in the system by a number, for example. Thus, a “1” can denote an indirect dependency and a “2” a direct dependency.

In one embodiment, if, for performing a process step, a selection can be made from a plurality of kitchen appliances stored in the resource storage device with which the process step can be performed, one combination possibility may differ from another combination possibility as described above in that in the first combination possibility, the process step is to be performed with a first kitchen appliance and in the second combination possibility the process step is to be performed with a second kitchen appliance. A kitchen appliance can then be selected by means of the optimizing device. Alternatively or additionally, the system comprises a selection device configured such that it selects a kitchen appliance from kitchen appliances stored in the resource storage device in an automated manner based on at least one selection criterion, when a process step can be performed with different kitchen appliances stored in the resource storage device.

As a selection criterion, it can be provided that from kitchen appliances stored in the resource storage device with which a process step can be performed, the kitchen appliance is selected which has already been used in a preceding process step. For example, a food processor and a mixing device are available. Food processor and mixing device are therefore stored in the resource storage device. According to a first process step, a first ingredient of a food has been chopped by the food processor. This first chopped ingredient is now to be mixed with a second ingredient. Two kitchen appliances are now available for mixing, namely the food processor and the mixing device. There is a need to select one of the two possibilities for mixing, either the food processor or the mixing device. Since the food processor has already been used in the preceding process step, the selection device selects the food processor for mixing the first and the second ingredient.

As a selection criterion, it can be provided that from kitchen appliances stored in the resource storage device with which a process step can be performed, the kitchen appliance is selected, which has already been used in a preceding process step, if a direct dependence exists between the process step and the preceding process step. In the above example, there is a direct dependency between the process step “mixing the first and the second ingredient” and the preceding process step “chopping the first ingredient”. Therefore, the selection device selects the food processor.

As a selection criterion it can be provided that from kitchen appliances stored in the resource storage device with which a process step can be performed, the kitchen appliance is selected, which has already been used in a preceding process step, if a direct dependence exists between the process step and the preceding process step and the process step can be performed quickly. “Can be performed quickly” means that there is a specified period of time within which the process step can be completely performed. For example, a short period of time can be 30 seconds, 60 seconds or 120 seconds. As period of time a value between 30 seconds and 120 seconds can be provided. In the above example e.g. the first and second ingredients are to be mixed for only 10 seconds. Therefore, the selection device selects the food processor.

As a selection criterion it can be provided that from kitchen appliances stored in the resource storage device with which a process step can be performed, the kitchen appliance which has already been used in a preceding process step is not selected if the process step can only be performed slowly, thus relatively much time is needed for its performing, but then the other kitchen appliance. In the above example e.g. first and second ingredient are to be mixed for 10 minutes. Therefore the selection device selects the mixing device.

As selection criterion it can be provided that from kitchen appliances stored in the resource storage device with which a process step can be performed, the kitchen appliance which has already been used in a preceding process step is not selected if the process step can be performed only slowly, thus relatively much time is needed for its performing, and the other kitchen appliance has a smaller range of functions. Then the selection device selects the other kitchen appliance.

A kitchen appliance has a smaller range of functions than another kitchen appliance if fewer different process steps can be performed with it compared to the different process steps that can be performed with the other kitchen appliance.

In the above example, for example, a first and a second ingredient are to be mixed for ten minutes. The mixing device can only be used for mixing. Therefore, the mixing device can only be used to carry out process steps in which ingredients are to be mixed. The food processor can also be used for mixing. Therefore, the food processor can be used to perform all process steps in which ingredients are to be mixed. However, the food processor can also chop ingredients or knead dough, for example. Therefore, the food processor can also perform process steps in which ingredients are to be chopped or dough is to be kneaded. Thus, the food processor has the larger range of functions. Therefore, in the above example, the selection device now selects the mixing device.

As a selection criterion, it can be provided that from kitchen appliances stored in the resource storage device with which a process step can be performed, the kitchen appliance which has already been used in a preceding process step is selected if the other kitchen appliance has a larger range of functions. For example, the mixing device has mixed a first and a second ingredient for ten minutes during a process step. A third ingredient is now to be added and then it is to be mixed for a further 180 seconds. The other kitchen appliance is a food processor. The selection device now selects the mixing device to perform the process step “180-second mixing of the three ingredients”.

A large number of recipes are known, for example the Thermomix® recipes mentioned at the beginning, which are adapted to the food processor Thermomix® TM6, i.e. which include, among other things, precise information on the settings to be made in the food processor Thermomix® TM6 in each case so that even an inexperienced user can produce a food reproducibly. It is desirable to complete such recipes with information in order to be able to use them according to the present disclosure. In order for the completion to be carried out in an at least partially automated manner, a text recognition is first carried out with a text recognition device, if required, so that the text of a recipe can be analyzed by an analysis device. The analysis device may comprise the text recognition device.

The analysis device can be configured such that it subdivides a recipe into modules. A module begins when a kitchen appliance is to be used for the first time according to the recipe. A module ends when the kitchen appliance is no longer to be used. A change of a kitchen appliance therefore results in the end of a preceding module and the start of a new module.

The analysis device may be configured such that it detects dependencies in an automated manner and to add corresponding information to the recipe. In order to detect dependencies in an automated manner, there may be a list of allowed words and/or of prohibited words stored in the analysis device. The analysis device may be configured to search a recipe for words, such as the word “vegetable broth”, in order to detect dependencies.

If the word “vegetable broth” is used in two consecutive process steps and the word “vegetable broth” is not a prohibited word and the two process steps are provided for the same kitchen appliance, the analysis device will assign, for example, a “2” to indicate that there is a direct dependency.

If the word “vegetable broth” is used in two consecutive process steps and the word “vegetable broth” is not a prohibited word and the two process steps are not provided for the same kitchen appliance, the analysis device will assign a “1”, for example, to indicate that an indirect dependency exists.

The analysis device can be configured such that it always identifies dependencies between process steps of a module as a direct dependency, for example by assigning a “2”.

Prohibited words may be provided because there are ingredients that are used so frequently that dependence cannot be inferred from repeated use of a corresponding word. For example, the word “onion” may be a prohibited word.

The present disclosure also relates to an analysis device as previously described.

To solve the task, a system with at least two kitchen appliances and a control device for the preparation of at least two foods is also provided. The control device is configured such that by a process step-by-process step instruction both foods can be prepared using a plurality of kitchen appliances. The process step-by-process step instruction is such that process steps for the preparation of one food are mixed with process steps for the preparation of the other food. Thus, the process steps for one food should not be carried out first, followed by the process steps for the other food. The sequence of the process steps is such that a specified optimization target can thereby be achieved. Such a system can be provided with the help of an optimizing device. Subsequently, it is no longer mandatory that, for example, the optimizing device is part of the system.

The sequence of the process steps in the system can be such that both foods are finished at the same time. The sequence of the process steps in the system can alternatively or additionally be such that both foods can be prepared as quickly as possible. The sequence of the process steps in the system can be such that a first food is finished at a desired first time and a second food is finished at a desired later time.

A method for the production of one or more foods according to a process step-by-process step instruction further serves to solve the task.

1. A system comprising
at least two kitchen appliances;
an electronic resource storage device for storing a list of kitchen appliances ;
a recipe storage device for storing a recipe for the preparation of a food;
an optimizing device configured such that it optimizes the preparation of one or more foods, taking into account information for the system comprised by a recipe; and
a control device for a preparation of one or more foods according to a sequence of process steps optimized by the optimizing device.

2. The system of claim 1, wherein at least one recipe is stored in the recipe storage device and the recipe is divided into a plurality of process steps, wherein the recipe includes information for the system for each process step.

3. that the system of claim 2, wherein information is selected from:
time specification for a process step;
kitchen appliance required for carrying out a process step and/or user required for carrying out a process step;
dependency between two process steps.

4. that the system of claim 3, wherein the recipe comprises dependencies between process steps as information and a distinction is made between two different dependencies.

5. The system of claim 4, wherein a distinction is made between a direct and an indirect dependency.

6. The system of claim 1, wherein the optimizing device comprises an input device through which a desired optimization target can be inputted.

7. The system of claim 6, wherein the system comprises a selection device configured such that the selection device selects in an automated manner from possible kitchen appliances stored in the resource storage device based on at least one selection criterion, when a process step can be performed with different kitchen appliances stored in the resource storage device.

8. The system of claim 7, wherein the selection criterion is one of the following selection criteria:
from kitchen appliances stored in the resource storage device with which a process step can be performed, the kitchen appliance is selected which has already been used in a preceding process step;
from kitchen appliances stored in the resource storage device with which a process step can be performed, the kitchen appliance is selected which has already been used in a preceding process step, if a direct dependency exists between the process step and the preceding process step;
from kitchen appliances stored in the resource storage device with which a process step can be performed, the kitchen appliance is selected which has already been used in a preceding process step, if a direct dependency exists between the process step and the preceding process step and the process step can be performed quickly;
from kitchen appliances stored in the resource storage device with which a process step can be performed, the kitchen appliance which has already been used in a preceding process step is not selected if the process step can only be performed slowly, but the other kitchen appliance is then selected; and
from kitchen appliances stored in the resource storage device with which a process step can be performed, the kitchen appliance which has already been used in a preceding process step is not selected if the process step can only be performed slowly and the other kitchen appliance has a smaller range of functions, but the other kitchen appliance is then selected.

9. The system of claim 8, wherein the optimizing device is configured such that it can calculate the sequence of process steps backwards.

10. The system of claim 1, wherein the system comprises at least one of (i) a food processor including a vessel, a mixing and cutting tool in the vessel, a heating device for the vessel, (ii) a mixing device, and (iii) a scale.

11. The system of claim 1, wherein the control device is configured such that by a process step-by-process step instruction both foods can be prepared using a plurality of kitchen appliances, wherein the process step-by-process step instruction is such that process steps for the preparation of one food are mixed with process steps for the preparation of the other food, and the sequence of the process steps is such that a specified optimization target can thereby be achieved.

12. The system of claim 11, wherein the system comprises a food processor and a mixing device, and according to the process step-by-process step instruction, the mixing device is to be used only when mixing is required for longer than a specified period of time.

13. The system of claim 11, wherein the two process step-by-process step instruction are such that both foods are finished at the same time.

14. The system of claim 13, wherein the food processor comprises a vessel with a mixing and cutting tool located therein having a blunt edge and an opposite sharp edge, a heating device for the vessel and a scale with which the weight of an ingredient in the vessel can be measured.

15. The system of claim 14, wherein the mixing device comprises a mixing and cutting tool having a blunt edge and an opposite sharp edge and the mixing device can rotate the mixing and cutting tool only in the direction of the blunt edge.

16. The system of claim 13, wherein the mixing device comprises a mixing and cutting tool having a blunt edge and an opposite sharp edge and the mixing device can rotate the mixing and cutting tool only in the direction of the blunt edge.

17. The system of claim 12, wherein the two process step-by-process step instruction are such that both foods are finished at the same time.

18. The system of claim 1, wherein the optimizing device is configured such that it can calculate the sequence of process steps backwards.

19. The system of claim 1, wherein the system comprises (i) a food processor including a vessel, a mixing and cutting tool in the vessel, a heating device for the vessel, (ii) a mixing device, and (iii) a scale.

20. The system of claim 1, wherein the system comprises a selection device configured such that the selection device selects in an automated manner from possible kitchen appliances stored in the resource storage device based on at least one selection criterion, when a process step can be performed with different kitchen appliances stored in the resource storage device.
